(19) United States
(12) Patent Application Publication
(10) Pub. No.: US 2020/0133263 A1
(43) Pub. Date: Apr. 30, 2020

(54) SYSTEM AND METHOD OF VALIDATION OF OPERATIONAL REGULATIONS TO AUTONOMOUSLY OPERATE A VEHICLE DURING TRAVEL

(71) Applicants: TOYOTA RESEARCH INSTITUTE, INC., Los Altos, CA (US); MASSACHUSETTS INSTITUTE OF TECHNOLOGY, Cambridge, MA (US)

(72) Inventors: JONATHAN DECASTRO, Los Altos, CA (US); Lucas Liebenwein, Cambridge, MA (US); Cristian-Ioan Vasile, Cambridge, MA (US); Russell Louis Tedrake, Los Altos, CA (US); Sertac Karaman, Cambridge, MA (US); Daniela Rus, Cambridge, MA (US)

(21) Appl. No.: 16/539,772

(22) Filed: Aug. 13, 2019

Related U.S. Application Data
(60) Provisional application No. 62/752,279, filed on Oct. 29, 2018.

(51) Int. Cl. G05D 1/00; G08G 1/048; G05D 1/02; G06K 9/00

(52) U.S. Cl. CPC G05D 1/0044; G05D 1/0088; G05D 1/0289; G05D 1/0212; G06K 9/00798; G08G 1/048

(57) ABSTRACT

System and method to autonomously operate a vehicle during travel are disclosed. Exemplary implementations may: generate, by sensors, output signals conveying contextual information and operational information, the contextual information characterizing a contextual environment surrounding the vehicle; obtain a current set of operational regulations; implement the current set of operational regulations to operate the vehicle autonomously; assess the validity of the current set of operational regulations within the updated contextual environment; responsive to the determining that the current set of operational regulations are valid within the updated contextual environment, return to implementation; responsive to the determining that the current set of operational regulations are invalid within the updated contextual environment, generate an updated set of operational regulations that are valid within the updated contextual environment; and responsive to generation, replace the current set of operational regulations with the updated set of operational regulations.

### CROSS-REFERENCE TO RELATED APPLICATIONS

This application claims the benefit of U.S. Provisional Patent Application No. 62/752,279, filed on Oct. 29, 2018, the contents of which is incorporated herein by reference in its entirety.

### TECHNICAL FIELD

The present disclosure relates generally to a system and method to autonomously operate a vehicle during travel, and more particularly to sustain the vehicle.

### BACKGROUND

Autonomous operation of a vehicle requires that the vehicle is capable of adapting to the most current environment. A vehicle environment may instantly change due to traffic, weather, or driving behaviors of surrounding vehicles. A driver of the vehicle may miscalculate timing when reacting to a change in the vehicle's environment. Therefore, a vehicle capable of assessing its environment in an ongoing manner and apply determined adaptations to the current operation of the vehicle as needed may be useful. By repeatedly applying adaptations, the autonomous vehicle may sustain operation.

### BRIEF SUMMARY OF THE DISCLOSURE

According to various embodiments of the disclosed technology, one aspect of the present disclosure relates to a vehicle configured to autonomously operate during travel. The vehicle may include one or more hardware processors configured by machine-readable instructions. The processor(s) may be configured to generate, by sensors, output signals conveying contextual information and operational information, the contextual information characterizing a contextual environment surrounding the vehicle. The operational information may specify operational settings of the vehicle during travel. The processor(s) may be configured to obtain a current set of operational regulations. The current operational regulations may specify restrictions on operation of the vehicle. The current set of operational regulations may be specific to a present contextual environment. The processor(s) may be configured to implement the current set of operational regulations to operate the vehicle autonomously. Subsequent to obtaining the current set of operational regulations, the processor(s) may receive the contextual information conveyed by the output signals and determine an updated contextual environment based on the contextual information. The processor(s) may be configured to assess the validity of the current set of operational regulations within the updated contextual environment. Assessing the validity of the current set of operational regulations may include determining whether the updated contextual environment includes an obstacle to avoid such that the position and/or motion of the obstacle is a variant of a previous position and/or motion of the obstacle. Assessing the validity of the current set of operational regulations may include utilizing the contextual parameters, e.g. the one or more characteristics of a moving obstacle, of the updated contextual environment. The processor(s) may be configured to, responsive to the determining that the current set of operational regulations are valid within the updated contextual environment, implement the current set of operational regulations. The processor(s) may be configured to, responsive to the determining that the current set of operational regulations are invalid within the updated contextual environment, generate an updated set of operational regulations that are valid within the updated contextual environment. The processor(s) may be configured to, responsive to generation of the updated set of operational regulations, replace the current set of operational regulations with the updated set of operational regulations. Subsequent to the replacement, the processor(s) may implement the current set.

As used herein, the term “determine” (and derivatives thereof) may include measure, calculate, compute, estimate, approximate, generate, and/or otherwise derive, and/or any combination thereof.

Another aspect of the present disclosure relates to a method to autonomously operate a vehicle during travel. The method may include generating, by sensors, output signals conveying contextual information and operational information, the contextual information characterizing a contextual environment surrounding the vehicle. The operational information may specify operational settings of the vehicle during travel. The method may include obtaining a current set of operational regulations. The current operational regulations may specify restrictions on operation of the vehicle. The current set of operational regulations may be specific to a present contextual environment. The method may include implementing the current set of operational regulations to operate the vehicle autonomously. Subsequent to obtaining the current set of operational regulations, the processor(s) may receive the contextual information conveyed by the output signals and determine an updated contextual environment based on the contextual information. The method may include assessing the validity of the current set of operational regulations within the updated contextual environment. Assessing the validity of the current set of operational regulations may include determining whether the updated contextual environment includes an obstacle to avoid such that the position and/or motion of the obstacle is a variant of a previous position and/or motion of the obstacle. Assessing the validity of the current set of operational regulations may include utilizing the contextual parameters, e.g. the one or more characteristics of a moving obstacle, of the updated contextual environment. The method may include, responsive to the determining that the current set of operational regulations are valid within the updated contextual environment, implementing the current set of operational regulations. The method may include, responsive to the determining that the current set of operational regulations are invalid within the updated contextual environment, generating an updated set of operational regulations that are valid within the updated contextual environment. The method may include, responsive to generation of the updated set of operational regulations, replacing the current set of operational regulations with the updated set of operational regulations. Subsequent to replacement of the current set, the method may include implementing the current set.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a system configured to autonomously operate a vehicle during travel, in accordance with one or more implementations.

FIG. 2 illustrates a method to autonomously operate a vehicle during travel, in accordance with one or more implementations.

The figures are not exhaustive and do not limit the present disclosure to the precise form disclosed.

### DETAILED DESCRIPTION

Vehicles capable of autonomous operation during travel may often times share the same environment as other autonomous vehicles or manually operated vehicles. Moreover, environments that the vehicle may be traversing in may unexpectedly change due to traffic, accidents, weather, and the like. In scenarios where the vehicle needs to avoid an obstacle and/or avoid causing a collision, a vehicle occupant may not be present and/or qualified to maneuver the vehicle accordingly and/or in time.

Autonomous vehicles may be classified into six different levels of autonomy. Level 0 indicates no automation, wherein a human driver must control steering, braking, accelerating, and determine traffic. Level 1 indicates driver assistance, wherein the vehicle may control either steering or speed, not both concurrently. The human driver is responsible for correcting and/or taking over if the driver assistance acts incorrectly. Level 2 indicates partial automation, wherein the vehicle may coordinate two or more driver assistance systems, such as adaptive cruise control and lane-keep assist. The human driver is responsible for calculated maneuvers, such as obeying traffic signals, and must still be vigilant in noticing potential dangers. Level 3 indicates conditional automation, wherein the vehicle can control steering, braking, and accelerating in most situations. The human driver must be alert and available to intervene when the vehicle indicates it cannot handle a situation. Level 4 indicates high automation, wherein the vehicle can operate with little to no human oversight or intervention under strict conditions, such as certain geographical areas or road types. Level 5 indicates full automation, wherein the vehicle can operate in any condition on any road a human can. The only involvement required at this level is entering an end destination.

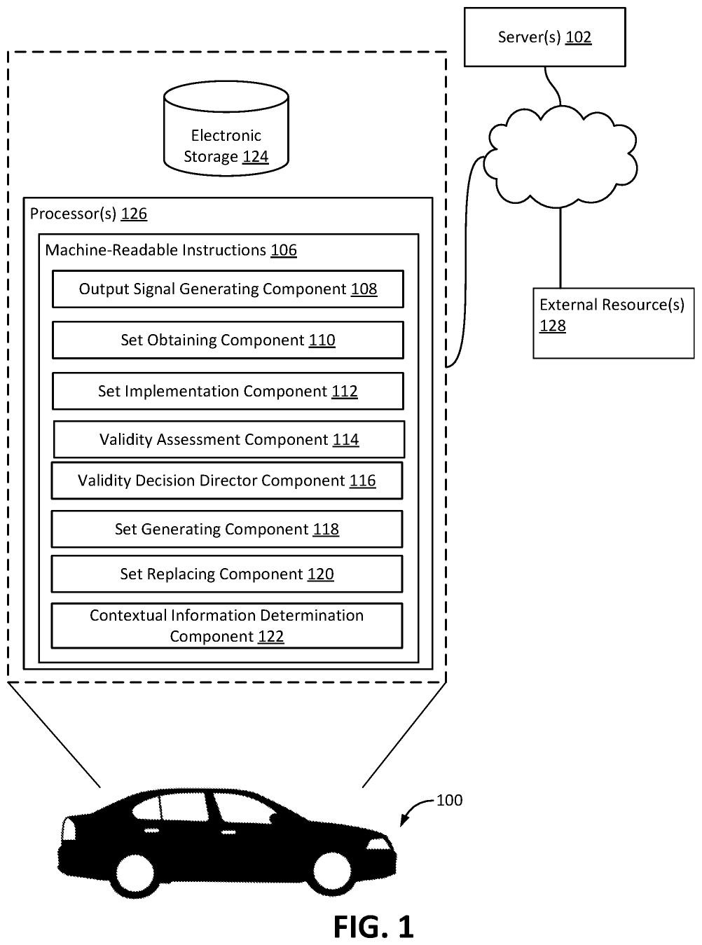

FIG. 1 illustrates a vehicle 100 configured to autonomously operate during travel, in accordance with one or more implementations. In some implementations, vehicle 100 may include one or more server(s) 102.

Vehicle 100 may be configured by machine-readable instructions 106. Machine-readable instructions 106 may include one or more instruction components. The instruction components may include computer program components. The instruction components may include one or more of an output signal generating component 108, a set obtaining component 110, a set implementation component 112, a validity assessment component 114, a validity decision director component 116, a set generating component 118, a set replacing component 120, contextual information determination component 122 and/or other instruction components.

Output signal generating component 108 may be configured to generate, by sensors, output signals conveying contextual information and operational information. The contextual information characterizes a contextual environment surrounding the vehicle. The contextual environment may be defined by parameter values for one or more contextual parameters. The contextual parameters may include one or more characteristics of a fixed or moving obstacle (e.g., size, relative position, motion, object class (e.g., car, bike, pedestrian, etc.), etc.), number of lanes, time of day, ambient conditions, direction of traffic in adjacent lanes, relevant traffic signs and signals, one or more characteristics of the vehicle (e.g., size, relative position, motion, object class (e.g., car, bike, pedestrian, etc.), etc.), and/or other contextual parameters. By way of non-limiting example, the contextual environment may include direction of travel of the vehicle, lane position of the vehicle on the roadway, topography of the roadway, obstacles in the roadway, traffic conditions, and/or others. The roadway may include a city road, urban road, highway, onramp, and/or offramp. Lane position of a vehicle on a roadway, by way of non-limiting example, may be that the vehicle is in the far left lane of a four lane highway. The topography may include changes in elevation and/or grade of the roadway. Obstacles may include one or more of other vehicles, pedestrians, bicyclists, motorcyclists, and/or other obstacles that a vehicle may need to avoid. By way of non-limiting example, an obstacle may be a tire shred from a previous vehicle accident. Traffic conditions may include slowed speed of a roadway, increased speed of a roadway, decrease in number of lanes of a roadway, increase in number of lanes of a roadway, increase volume of vehicles on a roadway, and/or others. Ambient conditions may include rain, hail, snow, fog, and/or other naturally occurring conditions. The operational information may specify operational settings of the vehicle during travel. By way of non-limiting example, the operational settings of the vehicle may include throttle position, brake engagement, and/or degree of steer. The contextual environment may be stored in and/or transferred in electronic files.

Sensors may include, by way of non-limiting example, one or more of an altimeter (e.g. a sonic altimeter, a radar altimeter, and/or other types of altimeters), a barometer, a magnetometer, a pressure sensor (e.g. a static pressure sensor, a dynamic pressure sensor, a pitot sensor, etc.), a thermometer, an accelerometer, a gyroscope, an inertial measurement sensor, global positioning system sensors, a tilt sensor, a motion sensor, a vibration sensor, an image sensor, a camera, a depth sensor, a distancing sensor, an ultrasonic sensor, an infrared sensor, a light sensor, a microphone, an air speed sensor, a ground speed sensor, an altitude sensor, medical sensors (including but not limited to blood pressure sensor, pulse oximeter, heart rate sensor, etc.), degree-of-freedom sensors (e.g. 6-DOF and/or 9-DOF sensors), a compass, and/or other sensors. As used herein, the term “sensor” may include one or more sensors configured to generate output conveying information related to position, location, distance, motion, movement, acceleration, and/or other motion-based parameters. Output signals generated by individual sensors (and/or information based thereon) may be stored and/or transferred in electronic files. In some implementations, output signals generated by individual sensors (and/or information based thereon) may be streamed to one or more other components of vehicle 100. Vehicle(s) 100 may be configured by machine-readable instructions 106.

Sensors may also include image sensors, cameras, and/or other sensors. As used herein, the term “sensor” may include any device that captures images, including but not limited to a single lens-based camera, a camera array, a solid-state camera, a mechanical camera, a digital camera, an image sensor, a depth sensor, a remote sensor, a lidar, an infrared sensor, a (monochrome) complementary metal-oxide-semiconductor (CMOS) sensor, an active pixel sensor, and/or other sensors. Individual sensors may be configured to capture information, including but not limited to visual information, video information, audio information, geolocation information, orientation and/or motion information, depth information, and/or other information. Information captured by one or more sensors may be marked, timestamped, annotated, and/or otherwise processed such that information captured by other sensors can be synchronized, aligned, annotated, and/or otherwise associated therewith. For example, contextual information captured by an image sensor may be synchronized with information captured by an accelerometer or other sensor. Output signals generated by individual image sensors (and/or information based thereon) may be stored and/or transferred in electronic files.

Set obtaining component 110 may be configured to obtain a current set of operational regulations. The current operational regulations may specify restrictions on operation of the vehicle. By way of non-limiting example, the restrictions on the operation of the vehicle may restrict one or more of speed, turn angle, braking speed, relative position of the vehicle with respect to one or more obstacles, position of vehicle on the roadway and/or within a lane on the roadway, and/or other aspects of the operation of the vehicle. The current set of operational regulations may be specific to a present contextual environment. The present contextual environment is the contextual environment the vehicle is currently in. The contextual environment may be defined by parameter values for one or more contextual parameters. The contextual parameters may include one or more characteristics of a fixed or moving obstacle (e.g., size, relative position, motion, object class (e.g., car, bike, pedestrian, etc.), etc.), number of lanes, time of day, ambient conditions, direction of traffic in adjacent lanes, relevant traffic signs and signals, and/or other contextual parameters.

In an example embodiment, the present contextual environment may be defined by contextual parameters, where the contextual parameters may include number of lanes, lane position of a primary vehicle, characteristics of a first vehicle relative to the primary vehicle, characteristics of a second vehicle relative to the primary vehicle, and topography of a roadway. The parameter values for the contextual parameter may include three lanes; middle lane position; positioned immediately to the left, speed of 67, motorcyclist; positioned to the right and behind, speed of 62, medium sized vehicle; and 3% decent grade, respectively. The current set of operational regulations that specify the restrictions on the operation of a vehicle for a present contextual environment may be a speed of 67 mph .

Set implementation component 112 may be configured to implement the current set of operational regulations to operate the vehicle autonomously. Upon implementation of a set of operational regulations, the vehicle may operate in a specified manner. Implementation includes actively restricting operation of the vehicle in accordance with a set of operational regulations or a determined updated set of operational regulations. Implementation may utilize a toolbox for planning, controlling, and analyzing nonlinear dynamical systems. For example, an updated set of operational regulations implemented upon a vehicle may include a restrictions of a speed of 60 mph and right side lane position.

Contextual information determination component 122 may be configured to determine the contextual environment the vehicle is current in based on the received contextual information. The contextual information that defines the contextual environment is defined by contextual parameters conveyed by the output signals, wherein the contextual parameters may be defined by one or more values. Contextual information determination component 122 may also determine an updated contextual environment based on the contextual parameters and parameter values. The contextual parameters and parameter values change in an ongoing manner as the sensors generate output signals in an ongoing manner. The updated contextual environment may include variants of the contextual information conveyed by the output signals.

In another example embodiment, the present contextual environment of a vehicle, conveyed via a sensor, may include contextual parameters and value corresponding values such that the vehicle traveling at a speed of 55 mph on a topography of a winding street. Upon receiving additional contextual parameters and its corresponding values, via sensors, ambient conditions may include rain and an updated contextual environment may be determined. The current set of operational regulations may need to be updated, such as the vehicle's speed and turning maneuvers.

Validity assessment component 114 may be configured to assess the validity of the current set of operational regulations within the updated contextual environment. Assessing the validity of the current set of operational regulations may include determining whether the updated contextual environment includes an obstacle to avoid such that the position and/or motion of the obstacle is a variant of a previous position and/or motion of the obstacle. Validity of the current set of operational regulations verifies the current set of operational regulations maintains sustainability of the vehicle, even in the updated contextual environment. Determining whether the updated contextual environment includes dynamically determining feasible trajectories that falsify sustainability such that an obstacle may need to be avoided. A falsification technique may include defining a formulation state space for a traffic system, a formulation set that satisfies sustainability, a formulation set that does not satisfy sustainability, and discretizing time with time steps. The falsification technique may utilize contextual parameters including, but not limited to, one or more characteristics of a moving obstacle, e.g. a proximate vehicle. Furthermore, falsification may include solving a direct-collocation trajectory optimization problem and utilizing the discretized time. The falsification technique may be a gradient-based approach.

Validity decision director component 116 may be configured to, responsive to the determining that the current set of operational regulations are valid or invalid within the updated contextual environment, return to implementation of the current set of operational regulations or proceed to generate an updated set of operational regulations, respectively. By way of non-limiting example, a determination that the current set of operational regulations is valid may include implementing, via the set implementation component 112, the vehicles speed and position on a roadway.

Set generating component 118 may be configured to, responsive to the determining that the current set of operational regulations are invalid within the updated contextual environment, generate an updated set of operational regulations that are valid within the updated contextual environment. The updated set of operational regulations may ensure sustainability of the vehicle, such that the vehicle may have been unsustainable for a period of time. Set generation component 118 may perform a reachability technique to generate the updated set of operation regulations for sustainability of the vehicle. The reachability technique may include utilizing the current set of operational regulations, selecting a hyperplane for each obstacle such that the updated set at a time step is a valid reachable set with respect to the updated contextual environment. Determining a reachable set may include using a Taylor expansion to the nonlinear dynamics and analyzing the reachable set in conjunction with road regulations computed by the Minkowski sum. A reachable set may include operational regulations that are possible to be implemented upon the vehicle. To compute the updated set, a selection of one hyperplane is made to maximize the volume of the updated set. The updated set of operational regulations may adjust the restrictions on the operation of the vehicle and/or permits circumvention on a set of road regulations. The updated set of operational regulations may include enablement of a collision to avoid a worse collision. By way of non-limiting example, the updated set of operational regulations may include enabling the vehicle to crash into a park vehicle and not a bicyclist. The set of road regulations may include utilizing turn signals, staying between lane markings, following an established speed limit, and/or other traffic rules. Circumvention of the set of road regulations may enable the vehicle to disregard one or more traffic rules to avoid an obstacle and/or collision. Circumvention of the set of road regulations may include ignoring utilization of turn signals, maneuvering over the lane markings, exceeding the established speed limit, and/or disregarding other traffic rules.

In an example implementation of circumvention of the set of road regulations, a vehicle may be permitted to cross a double yellow line on the left to avoid being side swiped by another vehicle on the right.

Set replacing component 120 may be configured to, responsive to set generating component 118, replace the current set of operational regulations with the updated set of operational regulations. Subsequent to replacement of the current set of operational regulations, implementation of the current set of operational regulations may occur via the set implementation component 112.

Continuing the example embodiment mentioned above, the additional vehicle quickly approaching the vehicle on an otherwise empty highway may cause the generation of an updated set of operational regulations such that the current set may no longer maintain sustainability of the vehicle. Therefore, the current set is determined to be invalid in the updated contextual environment. Consequently, the updated set of operational regulations may include enabling the vehicle to quickly switch lanes to the right. On the contrary, if the additional vehicle's speed decreased the close they got to the vehicle, the current set of operational regulations remain valid and no update is necessary.

The above mentioned machine-readable instructions including the above mentioned components and their functionality may execute in an ongoing manner such that the vehicle maintains sustainability on a roadway by sensing and reacting to its environment. Vehicle 100 may sense and react to its environment more efficiently than an occupant. In some or all limitation, machine-readable instructions 106 may be performed by server(s) 102.

In some implementations, vehicle 100, server(s) 102, and/or external resource(s) 128 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which vehicle 100, server(s) 102, and/or external resource(s) 128 may be operatively linked via some other communication media.

External resource(s) 128 may include sources of information outside of vehicle 100, external entities participating with vehicle 100, and/or other resources. In some implementations, some or all of the functionality attributed herein to external resource(s) 128 may be provided by resources included in vehicle 100. In some implementations, validity assessment component 114, validity decision director component 116, and set generating component 118 may be performed by external resource(s) 128 such that an updated set of operational regulations may be determined.

Vehicle 100 may include electronic storage 124, one or more processors 126, and/or other components. Vehicle 100 may include communication lines, or ports to enable the exchange of information with a network and/or other computing platforms. Illustration of vehicle 100 in FIG. 1 is not intended to be limiting. Vehicle 100 may include a plurality of hardware, software, and/or firmware components operating together to provide the functionality attributed herein to vehicle 100. For example, vehicle 100 may be implemented by a cloud of computing platforms operating together as vehicle 100.

Electronic storage 124 may comprise non-transitory storage media that electronically stores information. The electronic storage media of electronic storage 124 may include one or both of system storage that is provided integrally (i.e., substantially non-removable) with vehicle 100 and/or removable storage that is removably connectable to vehicle 100 via, for example, a port (e.g., a USB port, a firewire port, etc.) or a drive (e.g., a disk drive, etc.). Electronic storage 124 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 124 may include one or more virtual storage resources (e.g., cloud storage, a virtual private network, and/or other virtual storage resources). Electronic storage 124 may store software algorithms, information determined by processor(s) 126, information received from vehicle 100, and/or other information that enables vehicle 100 to function as described herein.

Processor(s) 126 may be configured to provide information processing capabilities in vehicle 100. As such, processor(s) 126 may include one or more of a digital processor, an analog processor, a digital circuit designed to process information, an analog circuit designed to process information, a state machine, and/or other mechanisms for electronically processing information. Although processor(s) 126 is shown in FIG. 1 as a single entity, this is for illustrative purposes only. In some implementations, processor(s) 126 may include a plurality of processing units. These processing units may be physically located within the same device, or processor(s) 126 may represent processing functionality of a plurality of devices operating in coordination. Processor(s) 126 may be configured to execute components 108, 110, 112, 114, 116, 118, 120, and/or 122, and/or other components. Processor(s) 126 may be configured to execute components 108, 110, 112, 114, 116, 118, 120, and/or 122, and/or other components by software; hardware; firmware; some combination of software, hardware, and/or firmware; and/or other mechanisms for configuring processing capabilities on processor(s) 126. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, and/or 122 are illustrated in FIG. 1 as being implemented within a single processing unit, in implementations in which processor(s) 126 includes multiple processing units, one or more of components 108, 110, 112, 114, 116, 118, 120, and/or 122 may be implemented remotely from the other components. The description of the functionality provided by the different components 108, 110, 112, 114, 116, 118, 120, and/or 122 described below is for illustrative purposes, and is not intended to be limiting, as any of components 108, 110, 112, 114, 116, 118, 120, and/or 122 may provide more or less functionality than is described. For example, one or more of components 108, 110, 112, 114, 116, 118, 120, and/or 122 may be eliminated, and some or all of its functionality may be provided by other ones of components 108, 110, 112, 114, 116, 118, 120, and/or 122. As another example, processor(s) 126 may be configured to execute one or more additional components that may perform some or all of the functionality attributed below to one of components 108, 110, 112, 114, 116, 118, 120, and/or 122.

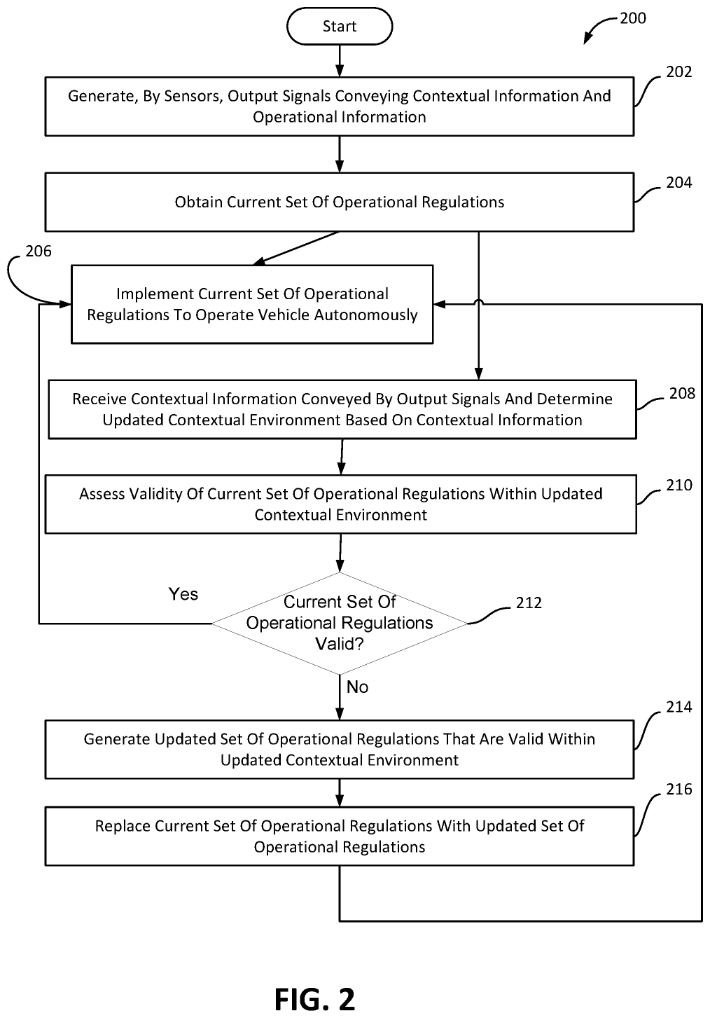

FIG. 2 illustrates a method 200 to autonomously operate a vehicle during travel, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include generating, by sensors, output signals conveying contextual information and operational information, the contextual information characterizing a contextual environment surrounding the vehicle. The operational information may specify operational settings of the vehicle during travel. Operation 202 may be performed by one or more hardware processors configured by machine-readable instructions including a component that is the same as or similar to output signal generating component 108, in accordance with one or more implementations.

An operation 204 may include obtaining a current set of operational regulations. The current operational regulations may specify restrictions on operation of the vehicle. The current set of operational regulations may be specific to a present contextual environment. The present contextual environment is the contextual environment the vehicle is currently in. Operation 204 may be performed by one or more hardware processors configured by machine-readable instructions including a component that is the same as or similar to set obtaining component 110, in accordance with one or more implementations.

Subsequent to operation 204, operation 206 may include implementing the current set of operational regulations to operate the vehicle autonomously. Operation 206 may be performed by one or more hardware processors configured by machine-readable instructions including a component that is the same as or similar to set implementation component 112, in accordance with one or more implementations.

Subsequent to operation 204, an operation 208 may include receiving the contextual information conveyed by the output signals and determine an updated contextual environment based on the contextual information. Operation 208 may be performed by one or more hardware processors configured by machine-readable instructions including a component that is the same as or similar to contextual information determination component 122 in accordance with one or more implementations.

An operation 210 may include assessing the validity of the current set of operational regulations within the updated contextual environment. Assessing the validity of the current set of operational regulations may include determining whether the updated contextual environment includes an obstacle to avoid such that the position and/or motion of the obstacle is a variant of a previous position and/or motion of the obstacle. Operation 210 may be performed by one or more hardware processors configured by machine-readable instructions including a component that is the same as or similar to validity assessment component 114, in accordance with one or more implementations.

An operation 212 may include responsive to the determining that the current set of operational regulations are valid or invalid within the updated contextual environment, returning to operation 206 or proceeding to operation 214, respectively. Operation 212 may be performed by one or more hardware processors configured by machine-readable instructions including a component that is the same as or similar to validity decision director component 116, in accordance with one or more implementations.

An operation 214 may include, responsive to the determining that the current set of operational regulations are invalid within the updated contextual environment, generating an updated set of operational regulations that are valid within the updated contextual environment. Operation 214 may be performed by one or more hardware processors configured by machine-readable instructions including a component that is the same as or similar to set generating component 118, in accordance with one or more implementations.

An operation 216 may include, responsive to operation 214, replacing the current set of operational regulations with the updated set of operational regulations. Subsequent to replacement of the current set of operational regulations, operation 206 may follow to implement the current set of operational regulations. Operation 216 may be performed by one or more hardware processors configured by machine-readable instructions including a component that is the same as or similar to set replacing component 120, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A vehicle configured to autonomously operate during travel, the vehicle comprising:
sensors configured to generate output signals conveying contextual information and operational information, the contextual information characterizing a contextual environment surrounding the vehicle, and the operational information specifying operational settings of the vehicle during travel; and
one or more processors configured by machine readable instructions to:
(a) obtain a current set of operational regulations, the current operational regulations specifying restrictions on operation of the vehicle, the current set of operational regulations being specific to a present contextual environment;
(b) implement the current set of operational regulations to operate the vehicle autonomously;
(c) subsequent to operation (a), receive the contextual information conveyed by the output signals and determine an updated contextual environment based on the contextual information;
(d) assess the validity of the current set of operational regulations within the updated contextual environment, wherein assessing the validity of the current set of operational regulations includes determining whether the updated contextual environment includes an obstacle to avoid such that the position and/or motion of the obstacle is a variant of a previous position and/or motion of the obstacle;
(e) responsive to determining at operation (d) that the current set of operational regulations are valid within the updated contextual environment, return to operation (b);
(f) responsive to determining at operation (d) that the current set of operational regulations are invalid within the updated contextual environment, generate an updated set of operational regulations that are valid within the updated contextual environment;
(g) responsive to performance of operation (f), replace the current set of operational regulations with the updated set of operational regulations; and
(h) subsequent to operation (g), return to operation (b).

2. The vehicle of claim 1, wherein the contextual environment includes direction of travel of the vehicle, number of lanes on a roadway, lane position of the vehicle on the roadway, topography of the roadway, position and motion of other vehicles, obstacles in the roadway, traffic conditions, and/or weather conditions.

3. The vehicle of claim 1, wherein the operational settings of the vehicle include throttle position, brake engagement, and/or degree of steer.

4. The vehicle of claim 1, wherein the restrictions on the operation of the vehicle control speed, turn angle, braking speed, and/or position of the vehicle.

5. The vehicle of claim 1, wherein the updated contextual environment includes variants of the contextual information conveyed by the output signals.

6. The vehicle of claim 1, wherein the obstacle includes one or more of another vehicle, a pedestrian, a bicyclist, and/or a motorcyclist.

7. The vehicle of claim 1, wherein the updated set of operational regulations adjusts the restrictions on the operation of the vehicle and/or permits circumvention on a set of road regulations.

8. The vehicle of claim 7, wherein the updated set of operational regulations includes enablement of a collision to avoid a worse collision.

9. The vehicle of claim 7, wherein the set of road regulations include utilizing turn signals, staying between lane markings, following an established speed limit, and/or other traffic rules.

10. The vehicle of claim 7, wherein the circumvention of the set of road regulations includes ignoring utilization of turn signals, maneuvering over the lane markings, and/or exceeding the established speed limit.

11. A method to autonomously operate a vehicle during travel, the method comprising:
Generating, by sensors, output signals conveying contextual information and operational information, the contextual information characterizing a contextual environment surrounding the vehicle, and the operational information specifying operational settings of the vehicle during travel;
(a) obtaining a current set of operational regulations, the current operational regulations specifying restrictions on operation of the vehicle, the current set of operational regulations being specific to a present contextual environment;
(b) implementing the current set of operational regulations to operate the vehicle autonomously;
(c) subsequent to operation (a), receiving the contextual information conveyed by the output signals and determine an updated contextual environment based on the contextual information;
(d) assessing the validity of the current set of operational regulations within the updated contextual environment, wherein assessing the validity of the current set of operational regulations includes determining whether the updated contextual environment includes an obstacle to avoid such that the position and/or motion of the obstacle is a variant of a previous position and/or motion of the obstacle;
(e) responsive to determining at operation (d) that the current set of operational regulations are valid within the updated contextual environment, returning to operation (b);
(f) responsive to determining at operation (d) that the current set of operational regulations are invalid within the updated contextual environment, generating an updated set of operational regulations that are valid within the updated contextual environment;
(g) responsive to performance of operation (f), replacing the current set of operational regulations with the updated set of operational regulations; and
(h) subsequent to operation (g), returning to operation (b).

12. The method of claim 11, wherein the contextual environment includes direction of travel of the vehicle, number of lanes on a roadway, lane position of the vehicle on the roadway, topography of the roadway, position and motion of other vehicles, obstacles in the roadway, traffic conditions, and/or weather conditions.

13. The method of claim 11, wherein the operational settings of the vehicle include throttle position, brake engagement, and/or degree of steer.

14. The method of claim 11, wherein the restrictions on the operation of the vehicle control speed, turn angle, braking speed, and/or position of the vehicle.

15. The method of claim 11, wherein the updated contextual environment includes variants of the contextual information conveyed by the output signals.

16. The method of claim 11, wherein the obstacle includes one or more of another vehicle, a pedestrian, a bicyclist, and/or a motorcyclist.

17. The method of claim 11, wherein the updated set of operational regulations adjusts the restrictions on the operation of the vehicle and/or permits circumvention on a set of road regulations.

18. The method of claim 17, wherein the updated set of operational regulations includes enablement of a collision to avoid a worse collision.

19. The method of claim 17, wherein the set of road regulations include utilizing turn signals, staying between lane markings, following an established speed limit, and/or other traffic rules.

20. The method of claim 17, wherein the circumvention of the set of road regulations includes ignoring utilization of turn signals, maneuvering over the lane markings, and/or exceeding the established speed limit.
